(19) United States
(12) Patent Application Publication
(10) Pub. No.: US 2006/0201362 A1
(43) Pub. Date: Sep. 14, 2006

(54) Method for producing a luminescent pattern from non-overlapping dots, and corresponding luminescent pattern

(76) Inventors: Thierry Dumery, Les Martres De Veyre (FR); Roger Vilcot, Perignat-Les-Sarlieve (FR)

Correspondence Address: BIRCH STEWART KOLASCH & BIRCH, PO BOX 747, FALLS CHURCH, VA, 22040-0747, US

(21) Appl. No.: 10/566,675

(22) PCT Filed: Jul. 22, 2004
(86) PCT No.: PCT/FR04/01945

§ 371 Date: Feb. 1, 2006

(30) Foreign Application Priority Data
Aug. 4, 2003 (FR) 03/09601

(51) Int. Cl. B41F 33/00

(52) U.S. Cl. 101/483

(57) ABSTRACT

The method of making a luminescent pattern comprises the steps of:
subdividing the pattern into an array (2) comprising a plurality of non-overlapping cells (3); on the basis of at least two luminescent materials that emit radiation of different colors when they are excited, and for each cell, determining a dot of luminescent material having dimensions that are no greater than the dimensions of the cell, and having a color that is appropriate for the radiation from adjacent dots in combination to reconstitute a corresponding zone of the pattern; and
printing the dots (4) as determined in this way in the corresponding cells of the array. The invention also relates to a luminescent pattern comprising a series of non-overlapping luminescent dots of at least two luminescent materials that emit different colors when they are excited, at least some of the dots emitting colors that combine to form at least a third color.

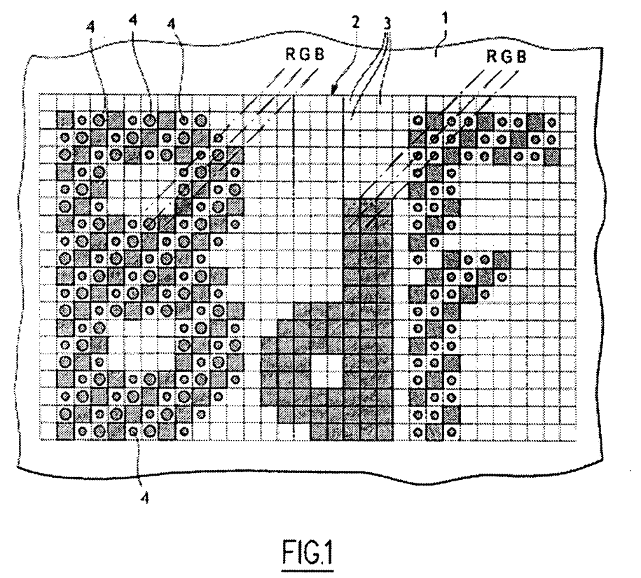

The present invention relates to a method of making a luminescent pattern and to the corresponding luminescent pattern, particularly although not exclusively, for making bank notes or bills secure.

### BACKGROUND OF THE INVENTION

In order to provide effective security for a document, in particular for a bank note, it is known that it is necessary to provide at least one sign on the document that cannot be reproduced by color photocopiers, even though their technical performance is increasing all the time.

Furthermore, it is known that in order to be effective, a security sign must be difficult for a counterfeiter to make, while being easy to check by a person verifying the authenticity of the document. In particular, it is necessary for the security sign to be sufficiently simple in terms of shape and color for a person carrying out a verification to be able to remember the authentic sign easily.

For the purpose of making security signs, use has already been made of materials that are luminescent (i.e. light-emitting), since they present the advantage whereby the luminescent effect cannot be reproduced by a photocopier.

Nevertheless, single luminescent materials that emit light with sufficient power to be checked by being analyzed visually are well known to counterfeiters. It is therefore possible for a counterfeiter to analyze the sign visually and then to reproduce it manually or by an additional printing step, such that the use of a single luminescent material does not constitute a sufficient security measure. Proposals have also been made to use compositions of luminescent materials comprising a variety of luminescent materials that form a light cascade amongst one another. Such compositions are satisfactory from the point of view of being difficult for a counterfeiter to reproduce, but the colors obtained are generally of low intensity and the shade of the color that is finally obtained is difficult to remember, which makes it difficult to check authenticity.

Proposals have also been made to superpose colors using conventional printing techniques consisting in depositing a plurality of different colors in succession. Nevertheless, the final color that is obtained, is the result of subtracting powers, and with the light emission from the lower layers being masked in part by the upper layers. The fluorescent image that is obtained is generally too weak to constitute a security sign.

### OBJECT OF THE INVENTION

An object of the invention is to propose a method of making a luminescent pattern of color that can be checked exactly while presenting light intensity that can also be checked, as can the corresponding luminescent pattern.

### BRIEF SUMMARY OF THE INVENTION

In order to achieve this object, the invention provides a method of making a luminescent pattern, the method being characterized in that it comprises the steps of:

subdividing the pattern into an array comprising a plurality of non-overlapping cells;

on the basis of at least two luminescent materials that emit radiation of different colors when they are excited, and for each cell, determining a dot of luminescent material having dimensions that are no greater than the dimensions of the cell, and having a color that is appropriate for the radiation from adjacent dots in combination to reconstitute a corresponding zone of the pattern; and

printing the dots as determined in this way in the corresponding cells of the array.

Thus, because of the lack of overlap between a dot printed in one cell and the dots in the adjacent cells, there is no subtractive effect, but on the contrary there is an additive effect of the light emitted by the various luminescent dots when they are excited, and a resultant color is obtained that becomes lighter when the dots in each cell are of a size that is as close as possible to the size of the cell.

In an advantageous version of the invention, the cells in the array are of mutually complementary shapes. It is thus possible to obtain maximum light intensity for the resulting pattern.

The invention also provides a luminescent pattern comprising a series of dots that do not overlap made up of at least two luminescent materials that emit different colors when excited, with at least some of the dots emitting colors that combine to form at least one third color.

### BRIEF DESCRIPTION OF THE DRAWING

The present invention can be better understood on reading the following description of a particular, non-limiting implementation of the invention, given with reference to the sole accompanying figure, which is a fragmentary and greatly enlarged view of a bank note including a pattern made in accordance with the invention.

### DETAILED DESCRIPTION OF THE INVENTION

In the figure, the pattern of the embodiment shown is constituted by the letters “BdF” printed on a bank note 1. To implement the method of the invention, the pattern is initially subdivided into an array 2 made up of a plurality of cells 3. In the example shown, the array 2 is constituted by square cells 3 touching one another in rows and columns. In the figure, the cells 3 are outlined by fine lines. In practice, the boundaries themselves are virtual for the purpose of defining printer files, but they are not printed in any way on the document.

In addition, in the figure, the size of the cells is very greatly exaggerated relative to the size of the pattern that is to be printed. In practice, in order to obtain the desired effects in satisfactory manner, it is possible to use an array 2 having square cells 3 of a side of length 100 micrometers (μm).

In the example shown, each cell then has allocated thereto a material that emits either a red color R, or a green color G, or a blue color B, when the material is excited by ultraviolet radiation. Each of these three colors is allocated in periodic manner to different cells in any given row, and there is a shift on each change of row, such that the cells to which the same color is allocated are disposed on diagonals, as represented by chain-dotted lines in the figure.

The size of each dot 4 is then determined so that each dot can constitute a corresponding zone of the pattern without overlapping any of the adjacent dots. In the example shown, the red dots R in the letter “B” are small round dots, while the green dots G are round dots of slightly greater size and the blue dots B are square in shape and cover the corresponding cell 3 completely. The resulting color that is obtained is blue. For the letter “d”, the dots are all square in shape and each of them covers the corresponding cell 3 in full. The resulting color that is obtained is white. For the letter “F” the red dots R are square in shape covering the corresponding cell 3 completely, the green dots G are round and small in size, while the blue dots are also round and small in size. The resulting color that is obtained is red.

After determining the kind of dot that is to be printed in each of the cells, the pattern is printed by any printing method, offset, photogravure, ink jet, . . . , that is best suited to the medium on which the pattern is to be printed and to the number of copies to be printed.

The final color of the pattern is essentially a function of the colors at which the luminescent materials in question emit light and also of the sizes of the dots. In practice, for an array of square cells have a side of 100 μm, dot size can be of the order of 15 μm to 100 μm depending on the desired light intensity. In the example shown above, it is assumed that printing is performed on white paper. It should be recalled that the paper will appear black when subjected to ultraviolet light. Given the sizes described for the dots, the letter “B” will thus appear blue at an intensity that is close to maximum intensity, the letter “d” will appear white with maximum intensity, and the letter “F” will appear dark red because of the small size of the majority of its dots.

Naturally, the invention is not limited to the embodiment described and variants can be applied thereto without going beyond the ambit of the invention as defined by the claims.

In particular, although the array is shown as being made up of square cells, it is possible to make an array using cells presenting any desired shape, for example cells that are hexagonal, or triangular and interleaved amongst one another, so as to cover the entire area that is occupied by the pattern. It is also possible to use an array in which the cells are not of complementary shape, for example the cells could be adjoining circular cells. Under such circumstances, because of the gaps between the cells, the colors that are obtained will be darker than in the above-described example, even if the dots of printed material cover each cell completely.

The array of cells 3 is not necessarily regular as shown in the figure, and on the contrary it could combine cells of different shapes and/or different sizes, thereby enabling a variety of optical effects to be obtained, in particular information could be incorporated in the luminescent pattern. A variety of optical effects can also be obtained by varying the relative positions of the different colors of luminescent dots.

The optical effects obtained by varying the shape and/or the size of the cells and by varying the relative positions of the colors of the luminescent dots can be observed either directly or else through a transparent color filter and/or a filter including an opaque array made of lines, dots, or a variety of shapes as a function of the pattern of the luminescent dots in order to mask certain luminescent dots in part or completely for the purpose of revealing the authentication pattern. It is also possible to reveal a digital watermark by examining the pattern as formed in this way by using a digital camera associated with image processing software enabling the combination of luminescent dots to be decoded.

Although the invention is shown using luminescent materials that emit in three different colors, the invention could be implemented by using only two colors, in particular when using two colors only makes it possible to reconstitute the final color that it is desired to obtain. Each luminescent material forming a dot can be constituted by a mixture of luminescent components. It is also possible to provide for all of the dots in a portion of the pattern to have the same color, for example to use a non-reconstituted color as a visual reference.

The invention applies to all luminescent materials regardless of the excitation radiation, in particular infrared. The luminescent materials may be fluorescent, phosphorescent with longer or shorter remanence, down-conversion luminescence, or anti-stoke luminescence, depending on the result color effects that are desired.

It is also possible to print the patterns by using luminescent materials that are excited at a variety of wavelengths, or that emit different colors depending on the excitation wavelength. During verification, different patterns then appear as a function of the excitation wavelength.

Under such circumstances, several implementations are possible. In a first implementation, the luminescent dots responding to a first excitation wavelength form a first pattern while the luminescent dots responding to a second excitation wavelength form a second pattern. The patterns are then preferably verified by exposing the document in succession to the first excitation wavelength and then to the second excitation wavelength. It should be observed in this context that the luminescent dots that respond to the first excitation wavelength may be different from the luminescent dots that respond to the second excitation wavelength, but that some or all of the luminescent dots may respond to both wavelengths, giving colors that differ depending on the excitation wavelength.

In a second implementation, the luminescent dots that respond to the first excitation wavelength and the luminescent dots that respond to the second excitation wavelength form a single pattern. Under such circumstances, the document should be subjected to a mixture of excitation wavelengths in order to reveal the pattern.

These two implements can also be combined by making a first pattern that is revealed by the first excitation wavelength, and a second pattern that is revealed by a mixture of a plurality of excitation wavelengths.

Naturally, it is possible to provide patterns that are made of luminescent dots that are excited by more than two different wavelengths, e.g. three different wavelengths.

It is also possible to combine luminescent dots that are excited by one or more wavelengths in the ultraviolet with luminescent dots that are excited by one or more wavelengths in the infrared.

The pattern excited by one or more wavelengths can also be revealed by interposing an appropriate filter. The filter may be a simply colored transparent filter and/or a filter itself including an opaque array made up of lines, dots, or a combination of shapes adapted to the distribution of the luminescent dots in order to mask some of the dots in part or in full.

In a variant, the luminescent dots form a first pattern when they are observed directly, and a second pattern when they are observed through a filter.

The shape of the printed dots may also vary as a function of the printer means used. As mentioned above, the shape of the dots is not necessarily the same as the shape of the cells. When using ink jet printing, each dot 4 shown in the figure may be made up of a plurality of droplets in order to vary the size of the dot. As with any dot-printing method, better definition is obtained using cells of small dimensions, but cost increases inversely with cell size. In practice, a cell having a size of 100 μm is a good compromise.

Without going beyond the ambit of the invention, it is also possible to combine luminescent dots seen together with dots that are visible in ordinary light. The luminescent dots can then be adjacent to the dots that are visible in ordinary light without overlapping them or they may be superposed thereon. With overlap, the luminescent dots are preferably located on top of the dots that are visible in ordinary light so that the luminescent light emission is not masked by the dots that are visible in ordinary light.

The luminescent dots of the invention may also be combined with a watermark. The luminescent dots are then preferably excited through the document, thus making it possible to verify not only the luminescent pattern and the watermark by recognizing them, but also how they are positioned relative to each other.

Although the invention is described above in relation to printing bank notes, the pattern of the invention could be printed on a film that is subsequently cut up to form stamps, or on a thread, or on a tape, for subsequent application on a document or for incorporation in the paper from which the document is made during the fabrication of the paper. With a transparent film, the pattern is preferably printed on a face of the film that is subsequently pressed against the document so that the pattern is protected by the film. It is also possible to cover printing of the invention in a protective varnish. When the pattern is carried by a transparent film, it is also possible to superpose the film on an optionally luminescent pattern that has previously been printed on the document by a conventional method or by the method of the invention, so that the authenticity of the document can be verified not only by verifying the existence and the color of the pattern, but also by verifying how it is positioned relative to the pattern printed on the document.

What is claimed is:

1-9. (canceled)

10. A method of making a luminescent pattern, the method comprising the steps of:
subdividing the pattern into an array (2) comprising a plurality of non-overlapping cells (3);
on the basis of at least two luminescent materials that emit radiation of different colors when they are excited, and for each cell, determining a dot of luminescent material having dimensions that are no greater than the dimensions of the cell, and having a color that is appropriate for the radiation from adjacent dots in combination to reconstitute a corresponding zone of the pattern; and
printing the dots (4) as determined in this way in the corresponding cells of the array.

11. A method according to claim 10, wherein the cells (3) of the array are of mutually complementary shapes.

12. A luminescent pattern comprising a series of non-overlapping luminescent dots of at least two luminescent materials emitting different colors when they are excited, wherein at least some of the dots emit colors that combine so as to form at least one third color.

13. A luminescent pattern according to claim 12, including luminescent dots that respond to different excitation wavelengths.

14. A luminescent pattern according to claim 13, wherein the luminescent dots form a variety of patterns as a function of the excitation wavelengths.

15. A luminescent pattern according to claim 12, including luminescent dots combined with dots that are made of material that is visible in ordinary light.

16. A luminescent pattern according to claim 12, including luminescent dots disposed in combinations that can be decoded by means of a filter.

17. A luminescent pattern according to claim 12, wherein the luminescent dots are combined with a watermark.

18. A luminescent pattern according to claim 12, wherein the luminescent dots are disposed so as to form a digital watermark suitable for analysis by a digital camera associated with image processing software.
